(19) United States
(12) Patent Application Publication
(10) Pub. No.: US 2007/0036525 A1
(43) Pub. Date: Feb. 15, 2007

(54) PORTABLE DIGITAL FILE CONVERTER AND DIGITAL FILE CONVERTING METHOD

(75) Inventor: Yao-Xun Chang, Taipei (TW)

Correspondence Address: KIRTON AND MCCONKIE, 60 EAST SOUTH TEMPLE,, SUITE 1800, SALT LAKE CITY, UT, 84111, US

(73) Assignee: APACER TECHNOLOGY INC., Taipei Hsien (TW)

(21) Appl. No.: 11/460,424

(22) Filed: Jul. 27, 2006

(30) Foreign Application Priority Data
Aug. 12, 2005 (TW) 094127635

(51) Int. Cl. H04N 5/00

(52) U.S. Cl. 386/125

(57) ABSTRACT

A portable digital file converter includes an input interface, a file system, a buffer, a central processing unit and a disc burner. The input interface is communicated with a digital video capture device or a data storage medium through a connecting port, so that a digital file is transmitted to the input interface. The file system is connected to the input interface. The buffer is connected to the file system for temporarily storing the digital file therein. The central processing unit is connected to the buffer for converting the digital file temporarily stored in the buffer into a converted digital file in a specified format, which is then stored in the buffer. The disc burner is communicated with the file system through an input/output interface for recording the converted digital file into a recordable disc loaded therein.

### FIELD OF THE INVENTION

The present invention relates to a portable digital file converter, and more particularly to a portable digital file converter for directly converting a digital file into a DVD format without using a personal computer. The present invention also relates to a digital file converting method.

### BACKGROUND OF THE INVENTION

Digital video capture devices such as digital still cameras, video cameras and camera phones have experienced great growth and are rapidly gaining in popularity. The digital video capture devices are used to capture video data in real time. For a purpose of recording high-quality and lengthy video data, the video cameras are predominant.

For most digital video capture devices, video data are recorded into digital data in a specified format such as MPEG2 (ISO13813) or MPEG4 (ISO14496). The digital data can be reproduced by the digital video capture devices per se or via a personal computer. Alternatively, the video data captured by the digital video capture devices can be converted into digital data by a specified application program installed in a personal computer and then recorded into a recordable disc loaded in the disc burner. Although the procedures of converting the video data into digital data and recording the digital data into a recordable disc are simply operated in a personal computer or a notebook computer, there are still some drawbacks. For example, these procedures are complicated for the uneducated users. Moreover, it is disadvantageous for carrying the weighty and bulky notebook computer and it is inconvenient for using the notebook computer to backup or share the video data in real time.

Conventional, the data storage units used in the digital video capture devices are exclusive magnetic tapes. Nowadays, diverse data storage units such as portable drives, micro drives or flash memory cards are used in the digital video capture devices for storing the video files. Moreover, a new approach is designed to synchronously burn the video data into the recordable disc. The portable drives, the micro drives and the flash memory cards are predominant because they have many advantages such as small size, light weightiness, easy portability and large memory capacity. The common memory card includes a compact flash card, a secure card, multi media card, a memory stick, a smart media card or a XD-picture card. The standard specifications of the memory cards used in the digital video cameras comprise for example SD_VIDEO, MEMORY STICK VIDEO, and so on.

For complying with the specific specification of the memory card, a specified application program is executed in the personal computer. Due to the amazing computing power of the personal computer, when the digital video capture device is linked to the personal computer, the user can convert and edit the video data by using the personal computer as an operating platform. For reproduce the video data, the video data should be directly outputted to a TV set or stored into a personal computer from the digital video capture device. Using the notebook computer only for creating backup digital video file is troublesome.

In views of the above-described disadvantages, the applicant keeps on carving unflaggingly to develop a digital file converter and a digital file converting method according to the present invention through wholehearted experience and research.

### SUMMARY OF THE INVENTION

An object of the present invention is to provide a portable digital file converter for directly converting a digital file from a micro drive or a memory card of a digital video capture device into a DVD format without using a personal computer, in which the converted digital file can be recorded into a recordable disc in a DVD format.

In accordance with an aspect of the present invention, there is provided a portable digital file converter. The portable digital file converter comprises an input interface, a file system, a buffer, a central processing unit and a disc burner. The input interface is communicated with a digital video capture device or a data storage medium through a connecting port, so that a digital file is transmitted from the digital video capture device or the data storage medium to the input interface. The file system is connected to the input interface. The buffer is connected to the file system for temporarily storing the digital file therein. The central processing unit is connected to the buffer for converting the digital file temporarily stored in the buffer into a converted digital file in a specified format, which is then stored in the buffer. The disc burner is communicated with the file system through an input/output interface for recording the converted digital file into a recordable disc loaded therein.

In accordance with another aspect of the present invention, there is provided a digital file converting method. The digital file converting method comprises steps of: (a) reading information files of a digital file; (b) creating DVD-format information files and retaining space required for a media object files according to the information of the information files; (c) reading the contents of the media object files allowable to be processed at a time according to the memory capacity; and (d) converting the media object files such that the information required for the DVD-format is written as the contents of the media object files in the memory.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic circuit block diagram of a digital file converter according to a preferred embodiment of the present invention;

FIG. 2 is a flowchart of a digital file converting method by using the digital file converter of the present invention; and

FIG. 3 schematically illustrates the comparison of the SD_video media object data file with the DVD video object data file.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

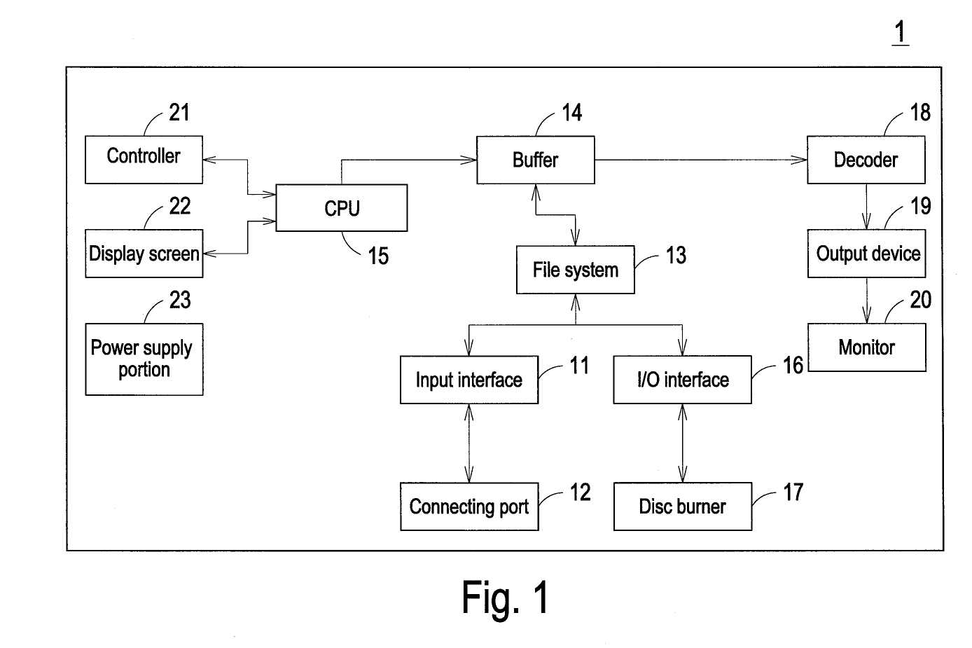

Referring to FIG. 1, a schematic circuit block diagram of a digital file converter according to a preferred embodiment of the present invention is illustrated. The digital file converter 1 of FIG. 1 comprises an input interface 11, a connecting port 12, a file system 13, a buffer 14, a central processing unit (CPU) 15, an input/output (I/O) interface 16 and a disc burner 17. By linking a connecting wire to the connecting port 12, the digital video capture device (not shown) is communicable with the digital file converter 1. The connecting port 12 is compatible with all specifications of memory cards. An exemplary connecting port 12 includes a universal serial bus (USB) port, a USB OTG (On-The-Go) port, an I-Link (IEEE 1394) port, an all-in-one card reader and the like. In a case that a digital video capture device (not shown) is communicated with the digital file converter 1 by linking a USB connecting wire to the connecting port 12 or inserting a memory card into the card reader, the digital files including at least information files and multimedia files and stored in the digital video capture device are transmitted to the input interface 11. The digital files are then transmitted into the buffer 14 and processed by the central processing unit 15, so that the digital files in a specified format such as MPEG2 (ISO13813) or MPEG4 (ISO14496) are converted into DVD-format digital files and temporarily stored in the buffer 14. Via the file system 13, the converted digital files are transmitted to the input/output interface 16 and the disc burner 17. An example of the disc burner 17 includes a DVD+/-R disc burner, a DVD+/-RW disc burner or the like. Meanwhile, the converted digital files are recorded into the recordable disc loaded in the disc burner 17.

For facilitating convenience, the digital file converter 1 further comprises a decoder 18, which is electrically connected to the buffer 14. The digital files temporarily stored in the buffer 14 are decoded by the decoder 18 and transmitted to a monitor 20 via a TV output device 19. The monitor 20 is for example a TV monitor. The converted digital files recorded into the optical disc by the disc burner 17 may be reproduced by the digital file converter 1 on the monitor 20. Alternatively, the converted digital files temporarily stored in the buffer 14 may be decoded by the decoder 18 to be directly displayed on the monitor 20 without the need of recording the digital files into the recordable optical disc and reading the digital files by the optical disc drive or DVD player.

Furthermore, the digital file converter 1 of the present invention comprises a controller 21, which is electrically connected to the central processing unit 15. The controller 21 includes at least one control button or switch. In response to a depressing operation on the control button or the switch, a file selecting operation or a burning operation is activated. The digital file converter 1 of the present invention further comprises a display screen 22, which is electrically connected to the central processing unit 15 for displaying the operating messages or the messages associated with the digital file converter 1. Moreover, the digital file converter 1 further comprises a power supply portion 23 to provide electricity required for the digital file converter 1. The power supply portion 23 includes for example a battery and/or is connected to the external power source via a cable (not shown).

In the above embodiments, by using the digital file converter 1 of the present invention, the digital files in a specified format such as MPEG2 (ISO13813) or MPEG4 (ISO14496) can be converted into DVD-format digital files. As a consequence, the movies or photographs captured by the digital file converter 1 can be directly converted into the DVD-format digital files so as to be reproduced via the general DVD player. In addition, the movies or photographs captured by the digital file converter 1 can be quickly recorded into the recordable disc so that more memory space is released for allowing the user to continuously capture the movies or photographs. During the traveling route, the user can carry this digital file converter 1 to capture numerous movies or photographs without the need of using a personal computer or a notebook computer and the related application program. Under this circumstance, the capacity of the micro drive or memory card in the digital video capture device is not critical because the movies or photographs captured by the digital file converter 1 can be quickly recorded into the recordable disc. Moreover, by using the digital file converter 1 of the present invention, the user can share the movies or photographs in real time with other users.

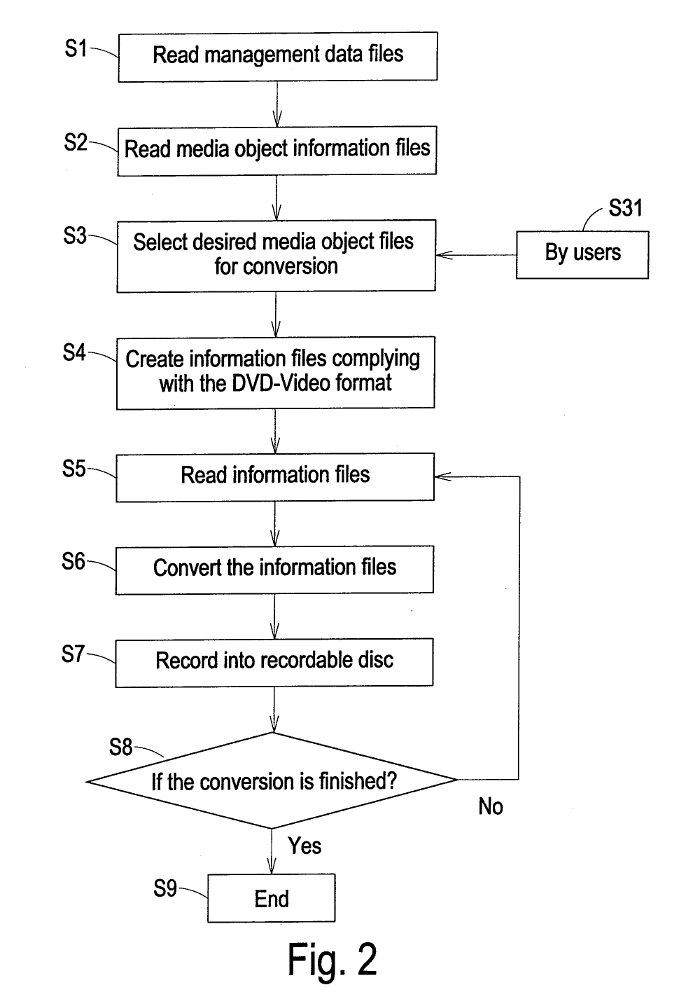

A flowchart of a digital file converting method by using the digital file converter 1 of the present invention will be illustrated with reference to FIG. 2. The digital video capture device in this embodiment is a digital video camera. Firstly, after the digital video camera is linked to the digital file converter 1 via a USB connecting wire, the management data files stored in the data storage unit of the digital video camera are read by the digital file converter 1 (Step S1). The management data files provide the global information that is used and updated by the digital video capture device to facilitate the digital file converter 1 understand the media configuration of the digital video capture device. The global information contains the total number of the media objects, the playback duration of each media segment, the attributes of the media objects, the names of the media object files, and so forth. Then, media object information files are read (step S2). The media object information files contain the information of the program stream such as the start/end time and total length of the media segment, the video/audio attributes and the contents of the media object. Moreover, for facilitating convenience and functionality, the information of the media object information files can be shown on the display screen 22 of the digital file converter 1. As a consequence, the user can select desired media object files for conversion (Step S3, S31). Alternatively, the desired media object files for conversion and the sequence thereof can be previously determined by creating a playlist management file in the digital video camera. According to the management information and the media information of the selected media object files, the information files complying with the DVD-Video format, which have extension names of ‘.IFO’ or ‘.BUP’, are created and the space for the media files having extension names of ‘.VOB’ is retained (Step S4). After the information files are created, the contents of the media files to be processed at a time according to the memory capacity are read (Step S5). Then, the procedure of converting the digital files are conducted (Step S6). During the converting procedure, by referring the differences between the common SD Video/Memory Stick Video format and the DVD-Video format, the information required for the DVD-Video format such as navigation data is written into the contents of the media files in the memory. Then, the converted media files are recorded into the recordable disc (Step S7). Due to limited memory capacity, if the media file is huge, the media file should be converted in segments or in batches. After the contents of the media files in the memory are recorded, if the selected files have been converted (Step S8), the digital file converting method of the present invention is finished (Step S9). Otherwise, the steps S5, S6 and S7 are repeated.

Hereinafter, the present invention will be well understood by converting the digital file of the common SD_video specification into the DVD-Video format. The video data complying with the SD_video specification are written in the specified format such as MPEG2 (ISO13813) or MPEG4 (ISO14496). The audio data are written in the specified format such as AC-3, AMR, AAC, Linear PCM, MPEG-1/Layer-2, PEG-2/Layer-2 and so forth. The management data files exist in the directory of “MGR_INFO”, and include the sections with filenames ‘MGR_DATA’, ‘PRG_MGR’ and ‘PLST_MGR’. The media object data files having extension names ‘.MOD’ and the media object information files having extension names ‘.MOI’ and the management information files PRG_INFO are stored in the directories of PRG001, PRG002, . . . , and so on. In comparison, the video data complying with the DVD-Video specification has a MPEG2 (ISO13813) format. The audio data are written in the format of AC-3, Linear PCM or MPEG-1/Layer-2. The information files and backup files complying with the DVD-Video format have extension names ‘.IFO’ and ‘.BUP’, respectively. The media object files have extension names ‘.VOB’. Although the video and audio data can be written in the MPEG2 format to comply with both the SD_video specification and the DVD-Video specification, there are some differences between the SD_video specification and the DVD-Video specification, especially in file management. Consequently, all of the information files and the media object data files complying with the SD_video specification should be systematically analyzed to determine the desired video and audio management data, and afterwards successively converted into the DVD-format digital files. In views of the data file conversion, the media object information files (.MOI) and the management data files (MGR_DATA, PRG_MGR, PRG_INFO) complying with the SD_video specifications are firstly analyzed and arranged. The specifications of the above files can be found in for example “SD Memory Card Specifications, Part 8. Video Specifications, Version 1.20, Chapter 5, Navigation”. Then, the arranged data complying with the SD_video specifications are written in the data fields required for the information files (.IFO). The specifications of the above data fields can be found in for example “DVD Specifications for Read-Only Disc, Part 3. Video Specifications, Version 1.12, Chapter 4, Navigation Data Structure.”

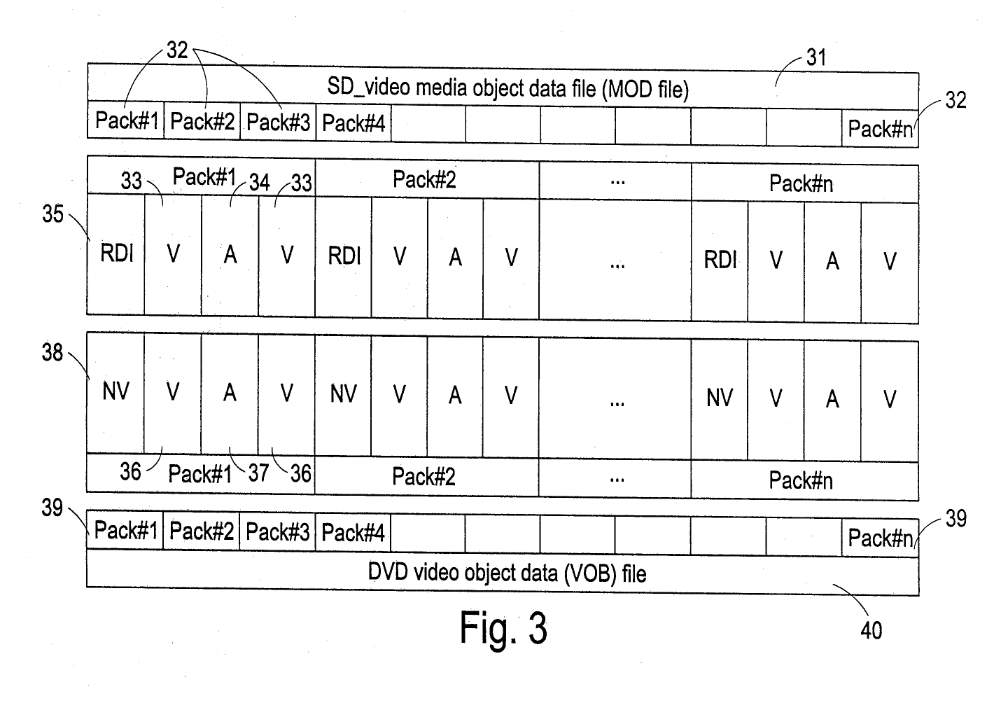

For example, please refer to FIG. 3, which schematically illustrates the comparison of the SD_video media object data file (MOD file) with the DVD video object data file (VOB file). Depending on the memory capacity, the SD_video media object data file (MOD file) is divided into several packets 32 (Pack#1˜Pack#n). Each of the packets Pack#1˜Pack#n comprises video files (V) 33, an audio file (A) 34 and a real-time data information file (RDI) 35. The specifications of the MOD files can be found in for example “SD Memory Card Specifications, Part 8. Video Specifications, Version 1.20, Chapter 7, Media Object Data File”. These files are successively converted into the DVD-Video digital files, i.e. the video files 36, the audio file 37 and a navigation file (NV) 38. These DVD-Video digital files are successively saved as packets 39 so as to compose a complete DVD video object data file (VOB file) 40. The specification of the DVD video object data file can be found in for example “DVD Specifications for Read-Only Disc, Part 3. Video Specifications Version 1.12, Chapter 4, Navigation Data Structure, Section 4, Presentation Control Information and Section 5, Data Search Information”. As a result, the compression rate of the converted digital files is minimized and the distorted video/audio quality is reduced.

The converted files are media object files (.VOB), information files (.IFO) and backup files (.BUP) to be stored in the memory or the storage medium. At this moment, the converted files fail to be directly recorded into the DVD-Video format recordable disc. In other words, the information and the configurations required for burning the recordable disc should be previously established according to the specifications described in “DVD Specifications for Recordable Disc for General (DVD-R for General), Part 2. File System Specifications, Version 2.1”, “DVD Specifications for Re-recordable Disc (DVD-RW), Part 2. File System Specifications, Version 1.01” and “Universal Disk Format Specification Revision 2.60”. Afterwards, the converted files will be recorded into the DVD-Video format recordable disc.

From the above description, the digital file converter of the present invention is capable of converting the digital files from a digital video capture device into DVD-format digital files by linking a connecting wire to the connecting port or inserting a memory card into the card reader. Since the micro drive has relatively large memory capacity and is likely prevailing in the further, the converted digital files can be recorded into a recordable micro drive. Moreover, since the digital file converter of the present invention is smaller and lighter than the personal computer or the notebook computer, the digital file converter is effective to backup or share the video data in real time by directly converting the digital file into DVD format wherever and whenever the users are. In addition, the DVD-format digital files can be recorded into a recordable CD or DVD disc, which can be reproduced by the DVD player.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A portable digital file converter comprising:
an input interface communicated with a digital video capture device or a data storage medium through a connecting port, so that a digital file having video data complying with MPEG2 specification is transmitted from said digital video capture device or said data storage medium to said input interface;
a file system connected to said input interface;
a buffer connected to said file system for temporarily storing said digital file therein;
a central processing unit connected to said buffer for converting said digital file temporarily stored in said buffer into a converted digital file complying with DVD_VIDEO specification, which is then stored in said buffer; and
a disc burner communicated with said file system through an input/output interface for recording said converted digital file into a recordable disc loaded therein.

2. The portable digital file converter according to claim 1 wherein said digital video capture device is a digital still camera, a video camera or a camera phone.

3. The portable digital file converter according to claim 1 wherein said data storage medium is a hard disc, a portable drive, a micro drive or a memory card.

4. The portable digital file converter according to claim 3 wherein said memory card includes a compact flash card, a secure card, multi media card, a memory stick, a smart media card or a XD-picture card.

5. The portable digital file converter according to claim 1 further comprising:
a decoder connected to said buffer for decoding said digital files temporarily stored in said buffer; and
a monitor for displaying thereon said decoded digital file.

6. The portable digital file converter according to claim 1 further comprising a controller, which is connected to said central processing unit and includes at least one control button activated to transmit an instruction to said central processing unit.

7. The portable digital file converter according to claim 1 further comprising a display screen, which is connected to said central processing unit for displaying thereon the operating messages associated with said portable digital file converter.

8. The portable digital file converter according to claim 1 further comprising a power supply portion, which includes a battery and is connected to an external power source.

9. The portable digital file converter according to claim 1 wherein said connecting port is a universal serial bus (USB) port connected to said digital video capture device or a card reader connected to said data storage medium.

10. The portable digital file converter according to claim 1 wherein said disc burner is a DVD+/-R disc burner or a DVD+/-RW disc burner.

11. The portable digital file converter according to claim 1 wherein the audio data of said digital file read from said digital video capture device or said data storage medium comply with the specification of AC-3, Linear PCM, and MPEG-1/Layer-2 format.

12. A digital file converting method executing on the portable digital file converter of claim 1, comprising steps of:
(a) reading a digital file having video data complying with MPEG2 specification;
(b) creating DVD_VIDEO information files according to said digital file;
(c) converting said video data of said digital file into DVD_VIDEO video object files.

13. The digital file converting method according to claim 12 wherein the step (a) further comprises a sub-step (a1) of selecting desired video data for conversion according to user instructions.

14. The digital file converting method according to claim 13 further comprising a step (e) of recording a DVD_VIDEO disc according to said information files and said video object files.
